(19) United States
(12) Patent Application Publication
(10) Pub. No.: US 2009/0108192 A1
(43) Pub. Date: Apr. 30, 2009

(54) Tritium-Tritium Neutron Generator Logging Tool

(75) Inventor: Joel L. Groves, Leonia, NJ (US)

Correspondence Address: SCHLUMBERGER OILFIELD SERVICES, 200 GILLINGHAM LANE, MD 200-9, SUGAR LAND, TX, 77478, US

(73) Assignee: Schulumberger Technology Corporation, Sugar Land, TX (US)

(21) Appl. No.: 11/924,450

(22) Filed: Oct. 25, 2007

(51) Int. Cl. G01V 5/10

(52) U.S. Cl. 250/269.4

(57) ABSTRACT

A neutron generator system is provided that uses substantially only the T-T fusion reaction to generate neutrons for a neutron borehole tool.

### BACKGROUND OF THE INVENTION

1. Field of the Invention

This invention relates broadly to the hydrocarbon industry. More particularly, this invention relates to neutron logging tools useful in the exploration of geological formation. The invention has particular application to accelerator-based neutron porosity tools although it is not limited thereto.

2. State of the Art

Conventional neutron porosity tools such as the CNT (a trademark of Schlumberger) tool or Compensated Neutron Tool, detect neutrons emitted by a radioisotope-based neutron source after they have traveled through the formation under investigation. The most common neutron source consists of radioactive americium (²⁴¹Am) combined with beryllium, or ²⁴¹Am(Be). The alpha particles emitted by ²⁴¹Am react with beryllium nuclei and emit neutrons (according to α(5.64 MeV)+⁹Be→¹²C+n (Q=+5.70 MeV)) of a broad spectrum of energies which span a range of slightly more than 11 MeV as seen in FIG. 1. Because of its broad energy spectrum, several different transport processes are involved as neutrons from the ²⁴¹Am(Be) source scatter through the formation and lose energy. For neutron energies above about 6 MeV, inelastic scattering is the dominant energy loss mechanism. For neutron energies below about 6 MeV, elastic scattering from hydrogen is the dominant energy loss mechanism. Thus, neutrons emanating from the ²⁴¹Am(Be) source will be subjected to both inelastic scattering and elastic scattering. The scattered neutrons are typically measured by neutron detectors spaced along the axis of the logging tool. The measured neutron detector count rates are converted into a log of the formation porosity. The neutron porosity log has become of great value to oilfield formation evaluation and many oilfield operators have built elaborate interpretation models using the neutron porosity measurements from a logging tool with an ²⁴¹Am(Be) source.

Other neutron sources have emission spectra different from the ²⁴¹Am(Be) source. For example, as seen in FIG. 1, a radioactive californium source has a peak at about 1 MeV, and emits few neutrons above 6 MeV. Accelerator-based neutron generators such as DD (deuterium source-deuterium target) and DT (mixed deuterium/tritium source and target, which is typically provided with between 50%-60% deuterium and 50%-40% tritium, and where the overwhelming interaction is deuterium-tritium fusion) typically emit neutrons at a single energy. For example, the DD neutron generator typically emits approximately 2.5 MeV neutrons, while the DT neutron generator typically emits approximately 14 MeV neutrons. As a result, the neutrons from Californium and DD neutron sources are generally subject to primarily elastic scattering, while the neutrons from DT are subject to both inelastic and elastic scattering because the neutrons from DT are subject to elastic scattering after the energies of the neutrons are first reduced by inelastic scattering.

For certain measurements such as formation porosity, tools which utilize an AmBe source and two detectors have been dominant in the marketplace. However, because of security issues associated with radioactive materials, it is no longer desirable to use AmBe as a source material.

### SUMMARY OF THE INVENTION

An accelerator-based neutron generator and a tool incorporating the generator are provided. According to the invention, the neutron generator is charged with substantially only tritium gas such that a tritium-tritium (T-T) fusion reaction is generated to the substantial exclusion of other reactions.

In one embodiment the neutron generator is substantially as shown in co-owned U.S. Pat. No. 5,293,410 to Chen et al., which is hereby incorporated by reference herein in its entirety, except that the generator is charged with substantially only tritium gas.

In another embodiment, the neutron generator charge with substantially only tritium gas is operated with the target at or near ground potential and the ion source floated at a high positive potential.

Advantages of the invention will become apparent to those skilled in the art upon reference to the detailed description taken in conjunction with the provided figures.

### BRIEF DESCRIPTION OF THE DRAWINGS

FIG. 1 is graph showing the neutron spectra from an ²⁴¹Am(Be) source, a ²⁵²Cf source, a D-T neutron generator, and a D-D neutron generator.

FIG. 2 is a graph showing the neutron spectrum generated from T-T fusion reactions.

FIG. 2a is a graph showing the spectrum of FIG. 2 added to the spectra of FIG. 1.

FIG. 3 is a neutron generator in accord with one embodiment of the invention.

FIG. 4 is a graph showing the cross-section for various fusion reactions as a function of kinetic energy.

FIG. 5 is a neutron generator in accord with a second embodiment of the invention.

FIG. 6 is a borehole tool utilizing a tritium-tritium fusion reaction neutron generator.

### DETAILED DESCRIPTION OF THE PREFERRED EMBODIMENTS

According to the invention, a neutron generator system is provided that uses substantially only the T-T fusion reaction to generate neutrons for a neutron borehole tool. The T-T fusion reaction is ₃¹T+₃¹T→₁⁰n+₁⁰n+₄²He Q=11.3 MeV. For purposes herein, the term “substantially only” means that at least 90% of all neutrons generated by the neutron generator, are generated by the T-T fusion reaction. Since the final state is a three-body system (a helium atom plus two neutrons), the kinetic energy of the neutrons can take on a range of values from very low energies to an energy near the reaction energy Q. In all cases, the sum of the kinetic energies of the neutrons plus the helium atom equals 11.3 MeV.

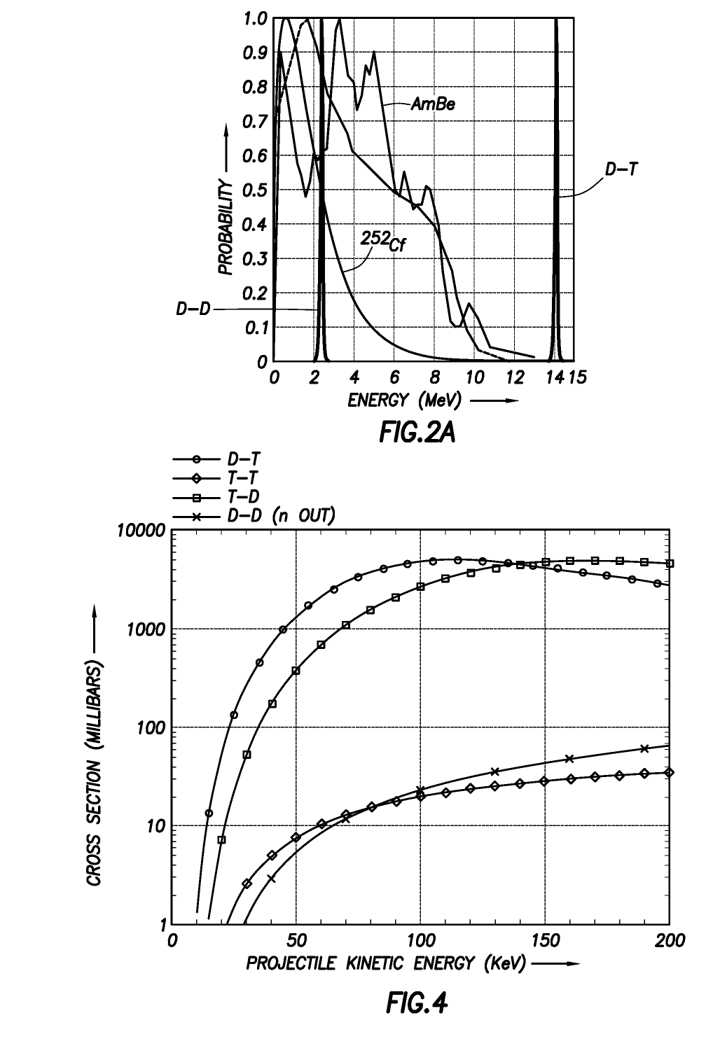

The T-T fusion neutron energy spectrum from 2 MeV to 10 MeV as measured by Y. Vu Glebov, T-T Fusion Neutron Spectrum Measured in Inertial Confinement Fusion Experiment, 48^{th} Annual Meeting of the APS, Div. of Plasma Physics, Philadelphia Pa. 30 Oct.-3 Nov. 2006 is seen in FIG. 2.

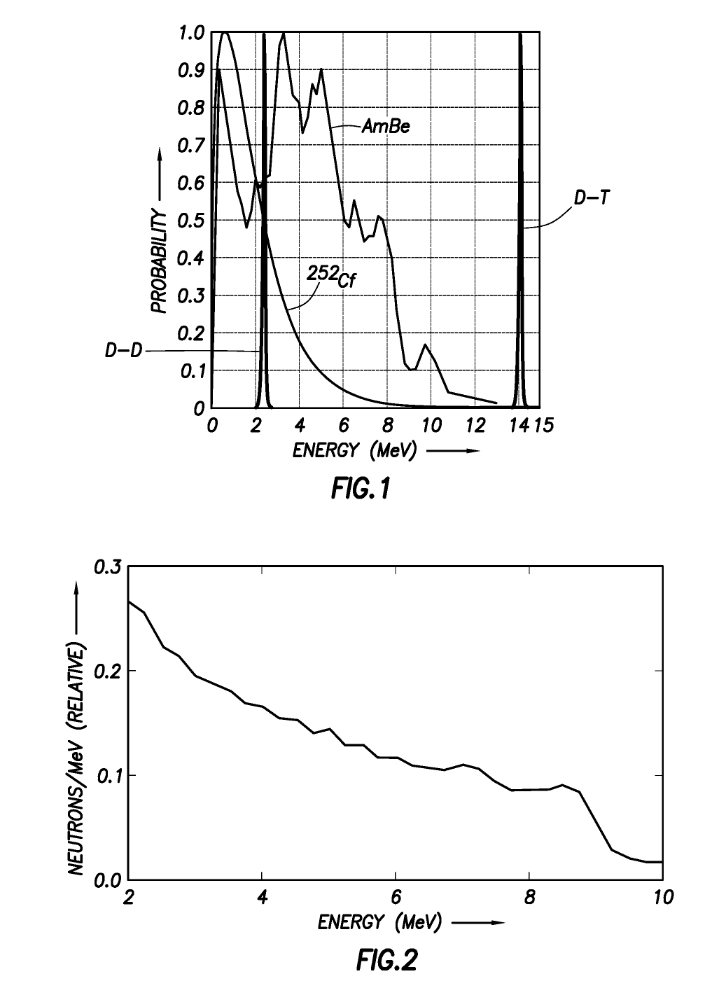

As seen in FIG. 2a, where the T-T fusion neutron energy spectrum is scaled and superimposed on the neutron spectra of FIG. 1 (with the dotted lines indicating expected values beyond what is provided in FIG. 2), the T-T spectrum has a breadth substantially similar to the ²⁴¹Am(Be) spectrum, with a probability similar to the ²⁴¹Am(Be) spectrum of having neutrons generated with energies above 6 MeV where inelastic scattering is the dominant energy loss mechanism, and a probability similar to the ²⁴¹Am(Be) spectrum of having neutrons generated with energies below 6 MeV where elastic scattering is the dominant energy loss mechanism.

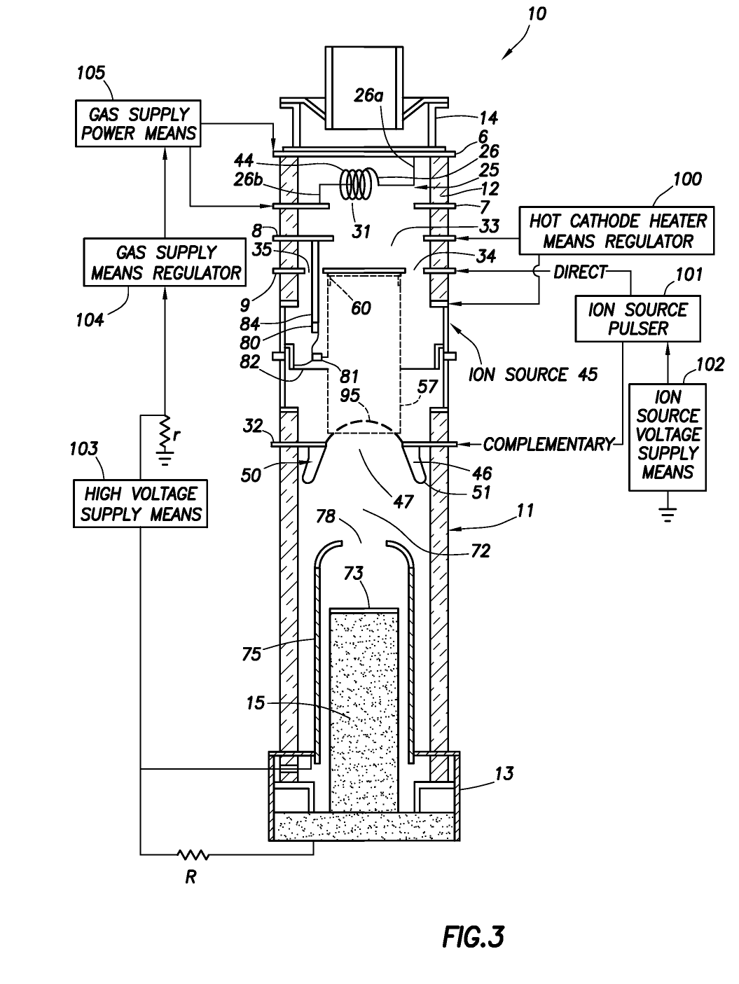

Turning now to FIG. 3, a neutron generator 10 according to a first embodiment of the invention is seen. FIG. 3 shows a neutron generator 10 which may be used in a logging tool such as described e.g. in U.S. Pat. Nos. 4,794,792, 4,721,853 or 4,600,838, which are hereby incorporated by reference herein in their entireties. The major components of the neutron generator 10 are a hollow cylindrical tube 11 made of an insulating material such as alumina ceramic and having its respective longitudinal extremities fixed to a ceramic ring 12 and a conductive ring 13, an ion source 45, a tritium gas supply means 25, an extracting electrode 50, and a massive copper target electrode 15. A transverse header 14 and the target electrode 15 close the rings 12 and 13, respectively, to provide a gas-tight cylindrical envelope. Ring 12 comprises parallel transversely disposed flanges 6, 7, 8, and 9, providing electrically conductive paths and sturdy support for the generator components as described subsequently in more complete detail. Flanges 6-9 are substantially equally spaced along ring 12, between header 14 and the corresponding extremity of tube 11. The tritium gas supply means 25 is disposed transversely to the longitudinal axis I-I of the generator 10, between first flange 6 and second flange 7, closest to header 14. The tritium gas supply means 25 comprises a helically wound filament 26 of tungsten, which may be heated to a predetermined temperature by an electric current from a gas supply power means 105 to which both ends 26a and 26b of filament 26 are connected.

A film 44 of zirconium or the like, for absorbing and emitting tritium, is coated on the intermediate turns of the filament 26 in order to provide a supply of tritium and to control gas pressure during generator operation.

As the tritium gas released from the film 44 is withdrawn from the atmosphere within the envelope for ion generation, more tritium is emitted to restore the envelope gas pressure to a level commensurate with the temperature of the intermediate portion of the filament helix 26. The tritium emitted by the film 44 diffuses through holes provided in flanges 7-9, i.e. a hole 31 in second flange 7, a hole 33 in third flange 8 and holes 34, 35 in fourth flange 9. The tritium emitted finally enters an ion source 45 interposed between the gas supply means 25 and the extremity of tube 11 facing ring 12. An annular shaped electrical insulator 90 is interposed between tube 11 and ring 12. More details on the structure of the neutron generator can be found e.g. in U.S. Pat. No. 3,756,682; or 3,775,216; or 3,546,512, which are herein incorporated by reference.

The ion source 45 comprises a cylindrical hollow anode 57 aligned with the longitudinal axis I-I of the generator 10 and made out of either a mesh or a coil. Typically, a positive ionizing potential (either direct or pulsed current) comprised in the range of 100-300 volts relative to the cathode, is applied to the anode 57. In one exemplary embodiment of the invention, the anode 57 is about 0.75 inch (1.9 cm) long and has a diameter of approximately 0.45 inch (1.14 cm). The anode 57 is secured rigidly to flange 9, e.g. by conductive pads 60.

The ion source 45 also includes a cathode 80 disposed close to the outside wall of the anode 57, in a substantially median position with respect to the anode. The cathode 80 comprises an electron emitter 81 consisting of a block of material susceptible, when heated, to emit electrons. Emitter 81 is fixed (e.g. by brazing) to the U-shaped end 82 of an arm 84 being itself secured to flange 8. The arm 84 provides also an electrical connection between the emitter 81 and a hot cathode heater current means 100 able to generate e.g. a few watts for heating the emitter. Heater current 100 is known per se (see U.S. Pat. No. 3,756,682, 3,775,216 or 3,546,512) and thus does not need to be further described. According to an alternate embodiment, as described in previously incorporated U.S. Pat. No. 5,293,410 to Chen et al., the cathode 80 could also comprise two arms (similar to arm 84), each provided at one of its ends with a block of dispenser material, both arms being disposed outside the hollow anode 57. This embodiment (cathode disposed outside the anode) prevents the material evaporated from the cathode from coating the surface of suppressor 75 causing enhanced field emission.

In a further alternate embodiment also described in U.S. Pat. No. 5,293,410 to Chen et al., the cathode 80 may also comprise a single arm provided at one end with an emitter, the arm being disposed inside the hollow anode 57, substantially in the center thereof. According to this embodiment, the cathode emitting surfaces are so arranged that electron emission is perpendicular to the axis of the ion source. This embodiment reduces the amount of cathode material being deposited on the suppressor surface.

Now described in more detail is the structure of the cathode 80. The thermionic cathode 80 comprises an emitter block including a material forming a substratum and a material susceptible to emit electrons. Thermionic cathodes here mean heated cathodes, as opposed to cold cathodes which emit electrons when not heated. The thermionic cathodes can be broken down into: (i) those with inherent electron emission capability if they can be heated high enough in temperature without melting (e.g. pure tungsten or tantalum or lanthanum hexaboride), and (ii) those to which use a low work function material is applied, either to the surface of a heated substratum (such as thoria coated tungsten, oxide coated) (called “oxide” cathode), or impregnated by bulk into a porous substrate (called “dispenser” cathode). General information on thermionic cathodes can be found in the book “Materials and Techniques for Electron Tubes” by W. Kohl, Reinhold Publishing, 1960, pages 519-566, which is herein incorporated by reference. In other words, “oxide” cathode involve what could be called a “surface” reaction, whereas in a “dispenser” cathode there occurs what could be called a “volume” reaction. General information on “dispenser” or “volume” type cathodes can be found e.g. in the article “Surface Studies of Barium and Barium Oxide on Tungsten and its Application to Understanding the Mechanism of Operation of an Impregnated Tungsten Cathode” by R. Forman, in Journal of Applied Physics, vol. 47, No 12, December 1976, pages 5272-5279; or in the article “A Cavity Reservoir Dispenser Cathode for CRT's and Low-cost Traveling-wave Tube Applications” by L. R. Falce, in IEEE transactions on electron devices, vol 36, No 1, January 1989. Cathodes of the “oxide” or “surface” type are described in the article “Compact Pulsed Generator of Fast Neutrons” by P. O. Hawkins and R. W. Sutton, The Review of Scientific Instruments, March 1960, Vol. 31, Number 3, Pages 241-248; in “Focused Beam Source of Hydrogen and Helium Ions” by G. W. Scott, Jr., in Physical Review, May 15, 1939, vol 55, pages 954-959; in U.S. Pat. No. 3,490,944 or U.S. Pat. No. 3,276,974; or in the article “Operation of Coated Tungsten Based Dispenser Cathodes in Nonideal Vacuum” by C. R. K. Marrian and A. Shih, in IEEE Transactions on Electron Devices, vol. 36, No 1, January 1989. All of the above mentioned documents are incorporated herein by reference.

The thermionic cathode 80 of the ion source of the present invention is preferably of the “dispenser” or “volume” type. A dispenser cathode used in a hydrogen environment maximizes electron emissions per heater power unit compared to other thermionic type cathodes (such as LaB₆ or W), while operating at a moderate temperature. The emitter block 81 comprises a substrate made of porous tungsten, impregnated with a material susceptible to emit electrons, such as compounds made with combinations of e.g. barium oxide and strontium oxide. Each cathode has different susceptibility to their operating environment (gas pressure and gas species). Dispenser cathodes are known to be the most demanding in terms of the vacuum requirements and care that is needed to avoid contamination. Preferably, the dispenser cathode works as long as several hundred hours in a hydrogen gas environment of pressure on the order of several mTorr, providing an average electron emission current of from 50 to 80 mA yet requires only a few watts of heater power.

The cathode 80 according to the invention is provided with hot cathode heater current 100 which is distinct from the ion source voltage supply 102. Such implementation permits a better control of both heater current means 100 and voltage supply 102.

The extracting electrode 50 is disposed at the end of the ion source 45 facing target electrode 15, at the level of the junction between tube 11 and ring 12. The extracting electrode 50 is supported in fixed relation to the ring 12 by a fifth flange 32. The extracting electrode 50 comprises a massive annular body 46, e.g. made of nickel or an alloyed metal such as KOVAR (trademark), and which is in alignment with the longitudinal axis I-I of the tube 11. A central aperture 47 in the body 46 diverges outwardly in a direction away from the ion source 45 to produce at the end of body 46 facing target electrode 15 a torus-shaped contour 51. The smooth shape contour 51 reduces a tendency to voltage breakdown that is caused by high electrical field gradients. Moreover, the extracting electrode 50 provides one of the electrodes for an accelerating gap 72 that impels ionized tritium particles from the source 45 toward a tritium-filled target 73. The target 73 comprises a thin film of tritium-filled titanium or scandium deposited on the surface of the transverse side, facing ion source 45, of the target electrode 15.

The potential that accelerates the tritium ions to the tritium-filled target 73 is established, to a large extent, between the extracting electrode 50 and a suppressor electrode 75 hereafter described. The suppressor electrode 75 is a concave member that is oriented toward the target electrode 15 and has a centrally disposed aperture 78 which enables the accelerated ions to from the gap 72 to the target 73. The aperture 78 is disposed between the target 73 and the extracting electrode 50. The suppressor electrode 75 is connected to a high voltage supply means 103 which is also connected, through a resistor “R” to the ground. In order to prevent electrons from being extracted from the target 73 upon ion bombardment (these extracted electrons being called “secondary electrons”), the suppressor electrode 75 is at a negative voltage with respect to the voltage of the target electrode 15.

The velocity of the ions leaving the ion source 45 is, on an average, relatively lower than ion velocity in a known Penning source. Consequently, these slow moving ions tend to generate a tail in the neutron pulse, at the moment the voltage pulse is turned off. The presence of an end tail is detrimental to the pulse shape so that is remedied by adding to the extractor a cut-off electrode, in the form of a mesh screen 95, which is fixed, e.g. by welding, to the aperture 47 of the extracting electrode 50, facing the ion source 45. The mesh screen 95 (cut-off electrode) is e.g. made of high transparency molybdenum. The cut-off electrode 95 is submitted to voltage pulses synchronized with and complementary to the voltage pulses applied to the anode 57. The pulses applied to cut-off electrode 95 are positive and e.g. of 100 to 300 volts. In an alternate embodiment, the cut-off electrode 95, instead of being submitted to voltage pulses, is maintained at a positive voltage, of e.g. a few volts. This low positive voltage prevents the slow ions produced at the end of the pulse in the ion beam from leaving the ion source, and thus allows one to truncate the terminal part of the ion beam, which in turn provides a sharp cut-off at the end of the neutron pulse (i.e. a short fall time). The cut-off electrode 95 is preferably made of a metallic grid in the form of a truncated sphere, and its concavity turned towards the target 73. Part of the mesh screen 95 might protrude inside cylindrical hollow cathode 57.

In an alternate embodiment, (wherein the extractor 50 is not provided with the cut-off screen 95), the end tail of the ion beam is truncated by applying a positive voltage pulse to the extracting electrode 50.

In order to generate a controlled output of neutrons, continuously or in recurrent bursts, an ion source voltage supply means 102 provides power for the bombarding ion beam. For pulse operation, an ion source pulser 101 is provided at the output of ion source voltage supply 102 to regulate the operation of voltage supply to the ion source. The ion source pulser 101 has a direct output connected to the anode 57 (via flange 9) and a complementary output connected to extracting electrode 50. The high voltage supply 103, the ion source voltage supply 102, and the ion source pulser 101 may be of any suitable type such as e.g. described in U.S. Pat. No. 3,756,682 or 3,546,512, already referred to. A gas supply means regulator 104 (connected to the high voltage supply means 103) regulates, through a gas supply power means 105, the intensity of the ion beam by controlling the gas pressure in the envelope. The current flowing through resistor r provides a measure of ion beam current which enables the gas supply regulator 104 to adjust the generator gas pressure accordingly. The voltage developed by the high voltage supply 103, moreover, is applied directly to the suppressor electrode 75 and through a resistor R to the target electrode 15. The voltages thus developed provide the accelerating and suppressor voltages, respectively. During operation, current is passed through the filament 26 of the tritium gas supply 25 in an amount regulated by the gas supply regulator means 104 to achieve a tritium pressure within the generator envelope that is adequate to obtain a desired ion beam current and ad hoc conditions for the generator to operate.

The high voltage established between the extracting electrode 50 and the suppressor electrode 75 produces a steep voltage gradient that accelerates tritium ions from the electrode aperture 47 in extracting electrode 50 toward the target 73. The energy imparted to the ions is sufficient to initiate neutron generating reactions between the bombarding ions and the target nuclei and to replenish the target 73 with fresh target material. After a short period of ion bombardment, a continuous or pulsed output ranging from 10⁷ to 10⁹ neutrons per second is reached.

As previously described, the regulator 104 regulates the power supplied to the filament 26 and thereby manipulates the tube gas pressure and the ion beam intensity to produce the desired neutron output. If the neutron output should increase as a result of an increase in the current, a corresponding increase in current through the resistor causes the regulator 104 to decrease the filament power supply and thereby reduce the gas pressure within the generator. The lower gas pressure in effect decreases the number of ions available for acceleration, and thus restores the neutron output to a stable, predetermined value. Similarly, a decrease in the current through the resistance causes the regulator 104 to increase the generator gas pressure.

If desired, the neutron output can be monitored directly, and either the ion source voltage supply or the high voltage power supply can be controlled automatically or manually to achieve stable generator operation.

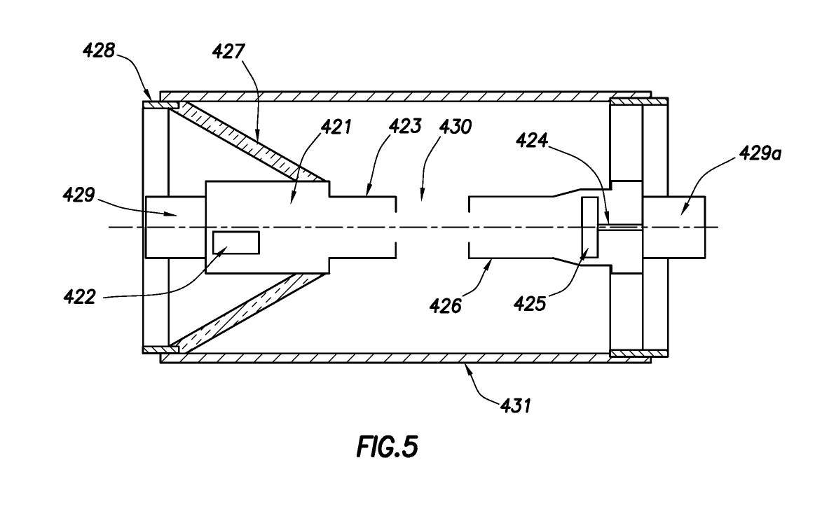

In FIG. 4, the cross-section for the T-T fusion reaction is shown as a function of the kinetic energy of the projectile tritium ions. Also shown are the cross-sections as a function of the kinetic energy for D-D reactions, D-T reactions (where the deuterium is the projectile and reacts with tritium in the target), and T-D reactions (where the tritium is the projectile and reacts with the deuterium in the target). Below 80 keV the T-T fusion cross section is larger than the D-D cross section. Since more than 90% of the ion beam projectiles incident on the target are molecular ions in the sealed neutron generators presently used in the art, most of the incident particle nuclei that undergo fusion will have a kinetic energy less than 80 keV. Also, each T-T fusion reaction produces two neutrons. Thus, the neutron output flux per unit ion beam current will likely be higher for a T-T neutron generator than for a D-D neutron generator. By way of example only, a T-T neutron generator operated with a beam current of 200 microamps at 150 kV will give a neutron flux of approximately 4×10⁷ neutrons per second.

Turning now to FIG. 5, a grounded target neutron generator 410 according to another embodiment of the invention is provided. The grounded target neutron generator 410 provides an increased neutron output relative to the neutron generator 10 of FIG. 3. In particular, grounded target neutron generator 410 includes a sealed accelerating tube 431 containing an ion source 421 with a T-T pressure managing device 422, an electrode 423, a target mounting assembly 424 with a tritium-infused grounded target 425, a suppression electrode 426, and a high voltage insulator 427. Sealing rings 428 are provided on both ends of the tube housing 431, and electric current feed-though elements 429, 429a are likewise provided. An acceleration gap area 430 is located between the ion source electrode 423 and the target electrode 426. Additional details on the structure of the neutron generator of FIG. 5 can be found in UK Patent Application GB 2429832A which is herein incorporated by reference herein.

It will be appreciated that according to another aspect of the invention, tritium-tritium fusion reaction neutron generators other than those shown in FIGS. 3 and 5 could be utilized, provided they are suitable of inclusion in a borehole tool. Preferably, the tritium-tritium fusion reaction neutron generator is capable of generating at least 5×10⁶ n/sec. More preferably, the tritium-tritium fusion reaction neutron generator is capable of generating at least 1×10⁷ n/sec. Most preferably, the tritium-tritium fusion reaction neutron generator is capable of generating 4.7×10⁷ n/sec or more. The more neutrons generated by the neutron generator, the higher the speed of operation of the borehole tool. In addition, because the neutron generators are for use in a borehole tool, the diameter of the neutron generator is preferably less than 10 inches, more preferably less than 8 inches, even more preferably less than 6 inches, and most preferably less than 4 inches.

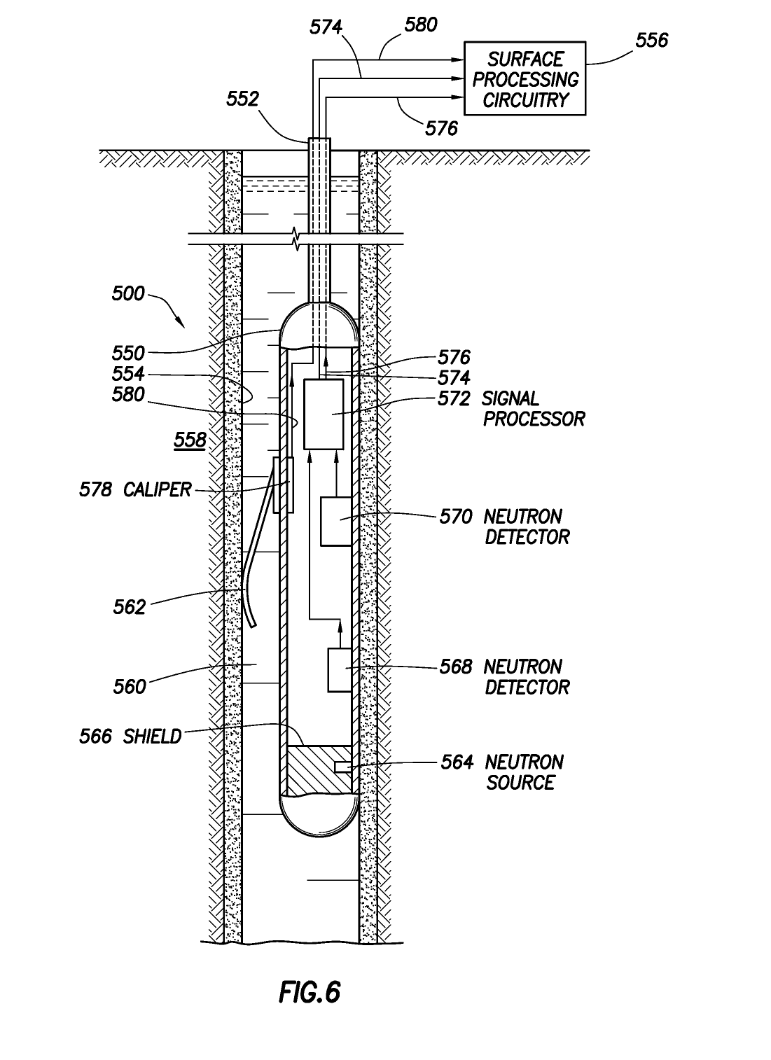

A borehole tool 500 utilizing a tritium-tritium fusion reaction neutron generator, e.g., the generator of FIG. 3 or FIG. 5, is shown in FIG. 6. More particularly, borehole tool 500 is preferably a compensated neutron logging tool, or dual-detector neutron tool which can be utilized to determine a porosity index of a subsurface geological formation 558 traversed by a borehole 554. A fluid-tight pressure resistant housing 550 is suspended by an armored cable 552 in a borehole 554. Cable 552 comprises insulated conductors that electrically connect the equipment within the housing 550 with surface processing circuitry 556 at the earth surface. A winch (not shown) is located at the surface and is used to lower and raise the housing 550 of logging tool 500 in the borehole 554 to traverse subsurface geological formations 558.

The borehole 554 may be dry or may be filled with drilling mud 560, as shown. To reduce the influence of the mud 560, a decentralizing mechanism, for example, a resiliently activated arm 562, may be pivotally attached to the housing 550 and urges its opposite side against the borehole wall to prevent the mud 560 from intervening between housing 550 and formation 558.

A tritium-tritium fusion reaction neutron generator 564, such as, e.g., the generator of FIG. 3 or FIG. 5, is placed in the lower most end of the housing 550 adjacent to the side that abuts the formation 558. Because the neutron generator 564 emit neutrons with equal probability in all directions, a copper neutron shield 566 may be placed around most of the neutron generator 564, except, of course, the side adjacent to the borehole wall. Such a shield thus scatters the largest possible number of neutrons toward the adjacent portion of the formation 558 and thereby enhances the statistical accuracy of the measurements.

Neutrons are transmitted by (emitted from) the neutron generator 564 diffuse through the formation 558. The neutrons are then registered by a short-spaced neutron detector, 568, and a long-spaced neutron detector 570 which are mounted within the housing above and generally in line with, the neutron generator 564. Typically, the near and far detectors, 568, 570 or signal sensors, each comprise a hollow cylindrical cathode filled with a neutron sensitive gas (e.g., helium-3). An anode wire (not shown) in the center of the cylinder creates a voltage gradient through the gas-filled cylinder, that enables ionized nuclear particles, produced as a consequence of neutron absorption within the gas nuclei to establish charged pulses in the detector electrodes. The long-spaced, or far, detector, or signal sensor 570 has a much larger volume than the short-spaced, or near, detector, or signal sensor, 568, in order to be more sensitive to neutrons. This arrangement of detectors having different sensitivities is provided to compensate for the exponential decrease in neutron population with an increased distance separation from the signal source 564.

It should be noted that the use of the terms “near-detector”, “short-spaced” detector, or signal sensor “spaced the least distance from the signal source” are used to describe a detector conventionally used in a logging tool, such as logging tool 500, wherein the spacing of the detector, or signal sensor 568, from the neutron generator 564 is an optimum compromise between the ability of the detector to measure the desired characteristic of the formation 558, while providing the best vertical resolution of the desired signal from the signal sensor. In other words, if the detector is spaced too close to the neutron generator 564, the desired measurement cannot be made. Further, the foregoing terms are not intended to encompass non-functional or non-operative detectors.

Pulses, or sensor signals, from the detectors 568 and 570 (representative of count rates) are passed to a downhole signal processor circuit 572 for transmission to the surface processing circuitry 556 through two conductors 574 and 576, respectively, in the armored cable 552, after discrimination against noise and amplification in a conventional manner. A borehole size indication may be obtained from caliper 578 combined with the decentralizing arm 562. The caliper 578 may transmit to the surface equipment 556, through a conductor 580 in the cable 552, signals that represent the borehole diameter in a conventional manner.

The surface processing circuitry 556 can be used to take the information provided by the detectors 568 and 570 and generate information regarding the formation such as porosity. As the manner of processing the data is well-known in the art, it is not described in more detail herein. Reference may be had to previously incorporated U.S. Pat. No. 4,794,792, 4,721,853 or 4,600,838,

There have been described and illustrated herein several embodiments of a neutron logging tool methods associated therewith. While particular embodiments of the invention have been described, it is not intended that the invention be limited thereto, as it is intended that the invention be as broad in scope as the art will allow and that the specification be read likewise. Thus, while use of the tritium-tritium neutron generator has been described with reference to a wireline tool, it will be appreciated that the neutron logging tool can be part of a logging-while-drilling LWD tool or other type of tool. Also, while the neutron logging tool has been described with particular reference to making porosity determinations, it will be appreciated by those skilled in the art that the neutron logging tool can be used for other purposes as well. Further, while a two-detector tool has been described it will be appreciated that a single detector or additional detectors could be utilized as well. Also, while particular tritium-tritium neutron generators were described for use in a neutron logging tool, it will be appreciated that other tritium-tritium neutron generators could be utilized. Further, while neutron generators where at least 90% (i.e., “substantially all”) of all neutrons generated by the neutron generator are generated by the T-T fusion reaction are preferred, neutron generators where at least 95% of all neutrons are generated by the T-T fusion reaction are more preferred. Most preferred are neutron generators where at least 99% of all neutrons are generated by the T-T fusion reaction. It will therefore be appreciated by those skilled in the art that yet other modifications could be made to the provided invention without deviating from its spirit and scope as claimed.

1. A tool for use in a borehole traversing a formation, comprising:
a) a housing;
b) a neutron generator charged with tritium gas such that at least 95% of neutrons generated by said neutron generator are generated by a tritium-tritium fusion reaction; and
c) at least one neutron detector spaced from said neutron generator, wherein said neutron generator and said at least one neutron detector are located in said housing wherein.

2. (canceled)

3. A tool according to claim 1 wherein: at least 99% of said neutrons are generated by a tritium-tritium fusion reaction.

4. A tool according to claim 1, wherein:
said at least one neutron detector comprises at least two neutron detectors.

5. A tool according to claim 1, further comprising:
a neutron shield located in said housing between said neutron generator and said at least one neutron detector, said neutron shield preventing neutrons from exiting said neutron detector and reaching said at least one neutron detector without first exiting said housing.

6. A tool according to claim 1, wherein:
said neutron generator generates at least 5×10⁶ n/sec.

7. A tool according to claim 6, wherein: said neutron generator generates at least 1×10⁷ n/sec.

8. A tool according to claim 7, wherein:
said neutron generator generates at least 4.7×10⁷ n/sec.

9. A tool according to claim 1, wherein:
said neutron generator comprises a helically wound filament charged with tritium and a target charged with tritium.

10. A tool according to claim 9, wherein:
said helically wound filament is comprised of tungsten and a film coated on said tungsten, wherein said film absorbs and releases tritium.

11. A tool according to claim 10, wherein:
said target comprises a thin film of tritium-filled titanium or scandium deposited on the a target electrode.

12. A tool according to claim 1, wherein:
said neutron generator has a tritium-charged grounded target.

13. A tool for use in a borehole traversing a formation, comprising:
a) a housing;
b) a neutron generator located in said housing and charged with tritium gas such that at least 95% of neutrons generated by said neutron generator are generated by a tritium-tritium fusion reaction, said neutron generator capable of generating at least 1×10⁷ neutrons per second;
c) two neutron detectors located in said housing and spaced from said neutron generator, wherein a first of said two neutron detectors is spaced a first distance from said neutron generator and a second of said two neutron detectors is spaced a second distance larger than said first distance from said neutron generator; and
d) a neutron shield located in said housing between said neutron generator and said at least one neutron detector, said neutron shield preventing neutrons from exiting said neutron detector and reaching said at least one neutron detector without first exiting said housing.
